(19) United States
(12) Patent Application Publication
(10) Pub. No.: US 2025/0184097 A1
(43) Pub. Date: Jun. 5, 2025

(54) USER EQUIPMENT INITIATED BEAM INDICATION

(71) Applicant: APPLE INC., CUPERTINO, CA (US)

(72) Inventors: Haitong Sun, Saratoga, CA (US); Wei Zeng, Saratoga, CA (US); Ankit Bhamri, Haar (DE); Dawei Zhang, Saratoga, CA (US); Hong He, San Jose, CA (US); Chunxuan Ye, San Diego, CA (US); Dan Wu, Beijing (CN)

(73) Assignee: APPLE INC., CUPERTINO, CA (US)

(21) Appl. No.: 18/935,249

(22) Filed: Nov. 1, 2024

Related U.S. Application Data
(60) Provisional application No. 63/605,140, filed on Dec. 1, 2023.

(51) Int. Cl. H04L 5/00; H04B 7/06; H04W 24/10

(52) U.S. Cl. CPC H04L 5/0091; H04B 7/0626; H04W 24/10

(57) ABSTRACT

The present application relates to devices and components, including apparatus, systems, and methods for user equipment (UE) to report its preferred transmission configuration indicator (TCI) state.

### CROSS-REFERENCES TO OTHER APPLICATIONS

This application claims priority to U.S. Provisional Application No. 63/605,140, for “USER EQUIPMENT INITIATED BEAM INDICATION” filed on Dec. 1, 2023, which is herein incorporated by reference in its entirety for all purposes.

### TECHNICAL FIELD

This application relates generally to communication networks and, in particular, to technologies for user equipment (UE) initiated beam indication.

### BACKGROUND

Third Generation Partnership Project (3GPP) Technical Specifications (TSs) provide details of radio interface protocols to facilitate communication over wireless networks. These TSs define transmission configuration indication (TCI), which is a signaling framework used for beam management. A beam for a target channel or signal, e.g., a control channel or a reference signal, can be indicated by a TCI state. This may improve coverage, reliability, or data rates. Further improvements in the TCI framework are desired.

### BRIEF DESCRIPTION OF THE DRAWINGS

FIG. 1 illustrates a network environment in accordance with some embodiments.

FIG. 2 illustrates a network environment in accordance with some embodiments.

FIG. 3 illustrates aspects of process timelines in accordance with some embodiments.

FIG. 4 illustrates a network environment in accordance with some embodiments.

FIG. 5 illustrates a network environment in accordance with some embodiments.

FIG. 6 illustrates a network environment in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

3GPP TSs describe operations that rely on transmission configuration indicator (TCI) states to facilitate communications. A TCI state may define a quasi-co-location (QCL) relationship between a source and a target. The source and target may be reference signals such as, for example, a synchronization signal block (SSB), channel state information-reference signal (CSI-RS) (for beam management or channel quality indicator (CQI) measurement), or a demodulation reference signal (DMRS). Channel properties (for example, spatial, time, or frequency domain properties) determined for the source may be inferred with respect to the target. Different QCL types indicate different channel properties may be inferred. For example, QCL Type A corresponds to Doppler shift, Doppler Spread, average delay, and delay spread; QCL Type B corresponds to Doppler shift, and Doppler spread; QCL Type C corresponds to Doppler shift and average delay; and QCL Type D corresponds to a spatial Rx parameter.

3GPP Release 15 (R15) and Release 16 (R16) introduced legacy TCI framework. The beam indication for downlink (DL) channels or signals may use TCI states, and the beam indication for uplink (UL) channels or signals may use spatial relations. Beam indication for different channels or signals, e.g., control channels, shared channels, or different reference signals, may use different mechanisms, e.g., radio resource control (RRC) signaling, medium access control (MAC) control element (CE), or downlink control information (DCI).

3GPP Release 17 (R17) and Release 18 (R18) introduced a unified TCI framework. The unified TCI state may refer to a TCI state that applies to multiple downlink or uplink channels. For example, a unified downlink (DL) TCI state may be applied to both a downlink data channel (e.g., a physical downlink shared channel (PDSCH)) and a downlink control channel (e.g., a physical downlink control channel (PDCCH), while a unified uplink (UL) TCI state may be applied to both an uplink data channel (e.g., a PUSCH) and an uplink control channel (e.g., PUCCH). The R17 and R18 unified TCI state supports two modes. In a first mode, a joint unified TCI state is applicable to both uplink and downlink channels. In a second mode, a DL TCI state is used for downlink channels, and a separate UL TCI state is used for uplink channels.

To support the two modes of R17 and R18, RRC signaling may be used to configure a UE with a pool of unified TCI states by signaling one or two lists. If only one list is used to configure the pool, the list will be a DL-or-joint-TCI-state list (dl-OrJoint-TCIStateList) having TCI states that will be used as joint unified TCI states. If two lists are used to configure the pool, the first list (dl-OrJoint-TCIStateList) will provide unified DL TCI states, and a second list, UL TCI state list (ul-TCI-StateList), will provide unified UL TCI states.

For example, in R17 unified TCI framework, up to 128 TCI states may be configured in dl-OrJointTCI-StateList for joint TCI mode, up to 128 TCI states may be configured in dl-OrJointTCI-StateList for DL unified TCI in separate TCI mode, and up to 64 UL TCI state may be configured in ul-TCI-StateList.

In the R17 and R18 unified TCI framework, the TCI states of a configured pool may be indicated/activated in one of two ways. In a first way, a MAC control element (CE) is used to indicate either a joint unified TCI state of the configured pool or to indicate one unified DL TCI state and one unified DL TCI state. In a second way, the MAC CE may activate a plurality of joint unified TCI states or a plurality of sets of unified UL/DL TCI states. Subsequently, DCI may be used to indicate one of the activated TCI/TCI sets that is to be used.

Two schemes of TCI state indication may be supported. In scheme 1, a common TCI indication may configure the TCI state for multiple channels or signals. For example, a common TCI may apply to dedicated channels, e.g., PDCCH, PDSCH, PUCCH, or PUSCH. The common TCI may apply to signals, e.g., aperiodic channel state information (CSI) reference signal (RS) for beam management (BM), or sounding reference signal (SRS) for codebook precoding (CB), non-codebook precoding (NCB), antenna switching (AS), or beam management (BM). The network may configure the UE with channels and signals associated with a common TCI state.

In scheme 2, a dedicated TCI indication may be used for a channel or a reference signal (RS). For example, a dedicated TCI indication may be used for periodic CSI-RS, semi-persistent CSI-RS, aperiodic CSI-RS for tracking, common PDCCH, or common PDSCH. The TCI state for some channels or signals may be configured with both schemes 1 and 2, while the TCI state for some channels or signals may be configured only with scheme 1 or scheme 2.

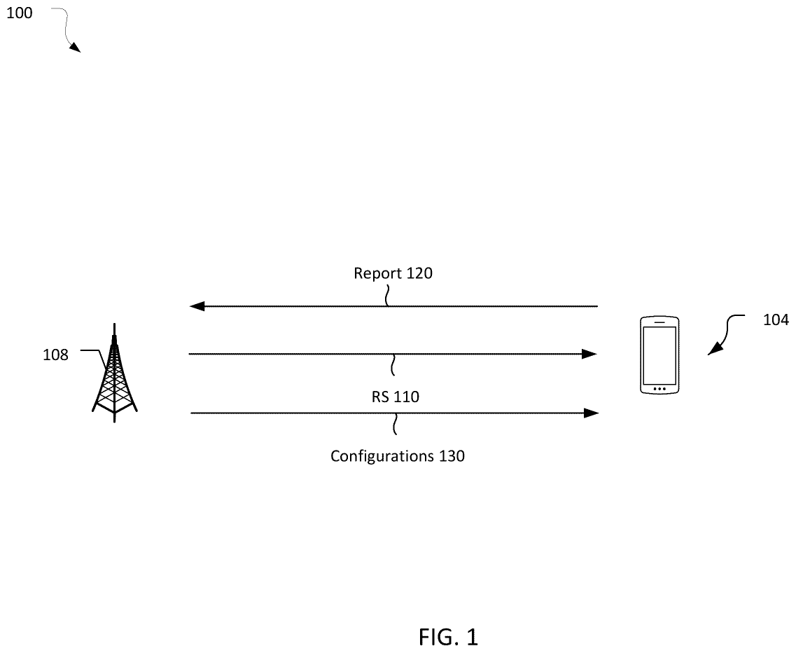

FIG. 1 illustrates a network environment 100 in accordance with some embodiments. The network environment 100 may include a user equipment (UE) 104 communicatively coupled with a base station 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and the base station 108 communicate may be compatible with 3GPP technical specifications (TSs), such as those that define Fifth Generation (5G) NR or later system standards (e.g., Sixth Generation (6G) standards). The base station 108 may provide user plane and control plane protocol terminations toward the UE 104.

The base station 108 may configure the UE 104 by sending configuration 130. The configuration 130 may be a Layer 1 (L1) signaling, e.g., physical layer messages, a Layer 2 (L2) signaling, e.g., a MAC-CE, or a Layer 3 (L3) signaling, e.g., RRC signaling. The configurations 130 may configure the UE with TCI states to be monitored, measured, or reported.

The configuration 130 may configure reference signal (RS) 110. For example, the configuration 130 may include the time and frequency resources on which the reference signal 110 is transmitted, whether the reference signal 110 is periodic, semi-persistent, or aperiodic, and an indication of the root sequence for the allocated reference signal. The UE 104 may use the reference signal 110 to perform measurements associated with a TCI state.

The configuration 130 may configure the UE 104 to report measurements associated with the reference signal 110 using report message 120. For example, the configuration 130 may include resources allocated for transmitting report 120.

In a legacy system, the base station 108 may configure, activate, or indicate the TCI for DL or UL channels or signals. Embodiments of the present disclosure describe aspects that the UE 104 provides its preferred TCI state to the base station 108.

In some embodiments, the UE 104 may use an L1 message, e.g., CSI report or physical random-access channel (PRACH), to indicate the TCI state to the base station 108. In other embodiments, the UE 104 may use an L2 (MAC layer) message, i.e., MAC-CE, to indicate the TCI state to the base station 108. In other embodiments, the UE 104 may use L3 (RRC layer) messages, i.e., RRC UE assistance information (UAI), to indicate the TCI state to the base station 108.

In some embodiments, the UE 104 may generate or report its preferred TCI state to the base station 108 only when certain conditions are met.

One condition may be when the quality of the currently activated TCI state is less than a threshold. The quality of the TCI state may be based on a reference signal received power (RSRP) measure, a signal-to-interference and noise ratio (SINR) measure, a block error rate (BLER) or bit error rate (BER) measure, or a data rate associated with the TCI state.

Another condition may be when the difference between the qualities of the activated TCI state and the preferred TCI state exceeds a threshold.

The thresholds may be configured by the base station 108, or 3GPP specifications may define them. For example, the base station 108 may configure the thresholds using RRC signaling.

The UE 104 may be configured with a prohibit timer to avoid frequent preferred TCI state reporting. After UE 104 reports its preferred TCI state, the UE 104 may start the prohibit timer. The UE 104 may not report another preferred TCI state unless the prohibit timer has expired. The base station 108 may configure the prohibit timer, or the 3GPP specification may specify the timer's duration.

In one embodiment, the UE's preferred TCI state may be a single unified TCI state. In another embodiment, the UE's preferred TCI state may be a pair of a single DL TCI state and a single UL separate TCI state. In another embodiment, the preferred TCI state may be a single DL separate TCI state or a single UL separate TCI state. In another embodiment, the preferred TCI report may include more than one unified TCI state.

In one embodiment, the report 120 may include an indication of the preferred TCI state and corresponding measurement, e.g., the RSRP or SINR measurement associated with the preferred TCI state. In another embodiment, the report 120 may include an indication of the preferred TCI state.

In one embodiment, the base station 108 may support a non-group-based operation. The UE 104 may report the TCI states that can be used for DL or UL operations. When the UE 104 reports multiple preferred TCI states, base station 108 may not use multiple TCI states for simultaneous operation in DL or UL.

In another embodiment, the base station 108 may support group-based operation. The UE 104 may report a pair of TCI states for DL or UL operations, and the base station 108 may use the pair of TCIs simultaneously for DL or UL operations.

In one embodiment, the UE may report the TCI state for simultaneous transmission cross 2 panels (ST×2P). In some instances, the UE may report a pair of TCI states, and the base station 108 may use the pair of TCI states simultaneously for both DL and UL operations. In some instances, the UE may report separate pairs of TCI states. The base station 108 may use one reported pair of TCI states simultaneously for DL operation. The base station 108 may simultaneously use the other reported pair of TCI states for UL operation.

In one embodiment, the UE may report its preferred TCI state for DL or UL's multi-transmission reception point (TRP) operation. The UE may report different TCI states for different TRPs.

When UE 104 is configured with carrier aggregation or dual connectivity, the UE 104 may use the same radio frequency (RF) components, e.g., phase shifter, for the configured component carriers. Therefore, the UE may use the same TCI state across multiple component carriers that share the same RF components. Similarly, the base station 108 may use the same TCI state across multiple component carriers that share the same RF components.

In one embodiment, the UE may report the list of component carriers that share the same TCI state or spatial relation. In some instances, the UE 104 may report the list of component carriers as UE capability report, e.g., via RRC signaling. In some instances, the UE 104 may report the list of component carriers using UE assistance information via RRC signaling. The UE 104 may report the list of component carriers using MAC-CE or L1.

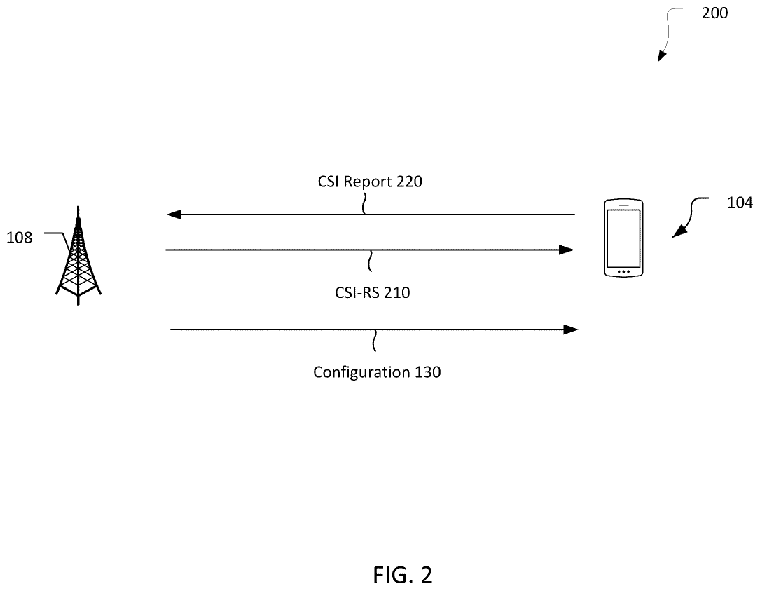

FIG. 2 illustrates a network environment 200 in accordance with some embodiments. The configuration 130 may configure the UE 104 with CSI-RS 210 and CSI report 220. The configuration 130 may configure the UE 104 with multiple CSI-RSs, each reference signal associated with one or more TCI states. The configuration 130 may configure the UE 104 with multiple CSI-RS reports, all denoted by CSI reports 220.

In one embodiment, the UE 104 may report its preferred TCI state using a CSI report 220. The UE may send the CSI report 220 carrying the preferred TCI state over PUCCH or PUSCH. For example, the UE 104 may generate and send periodic CSI reports and semi-persistent CSI reports activated by MAC-CE on PUCCH. The UE 104 may generate and send aperiodic CSI reports and semi-persistent CSI reports activated by DCI on PUSCH. In some instances, the CSI report 220 carrying the preferred TCI state may be transmitted over PUCCH.

The configuration 130 may configure the UE 104 with the resources for reporting TCI states. For example, the configuration 130 may configure interference measurement resource (IMR) resources or channel measurement resource (CMR) for carrying the UE's preferred TCI state. The base station 108 may explicitly configure the resources. For example, the configuration 130 may include a list of TCI states for UE to report in the CSI report configuration.

The base station 108 may implicitly configure the CMR, e.g., not configuring CMR using CSI report configuration. The base station 108 may rely on other configurations to inform the UE 104 the list of TCI states. In some instances, configuration 130 may be an RRC configuration signal that may include a list of TCI states. For example, the dl-OrJointTCI-StateList or ul-TCI-StateList RRC information elements (IEs) may be used to configure the TCI states for joint TCI or separate TCI modes.

In some instances, the base station 108 may provide a list of TCI states in MAC-CE. The MAC-CE may provide a list of activated TCI states, and the UE may select its preferred TCI state from the MAC-CE activated list.

Denote the CSI report carrying UE's preferred TCI state with the TCI-CSI report. The TCI-CSI report's transmission schedule may collide with the schedule for transmission of normal CSI reports, e.g., CSI reports carrying reference signal received power (RSRP) or signal-to-interference and noise ratio (SINR) information. The UE 104 may order transmission of the CSI reports. The UE 104 may select the TCI-CSI report or the normal CSI report to be transmitted. For example, the UE 104 may use the respective priorities associated with the TCI-CSI report and the normal CSI report to decide which one may be transmitted.

In one instance, the TCI-CSI and normal CSI reports may have the same priority. The TCI-CSI report and normal CSI report may have different priorities. For example, a TCI-CSI report may have a higher priority than a normal CSI report or a TCI-CSI report may have a lower priority than a normal CSI report.

In one instance, a CSI report may be associated with a priority value Pri_{CSI}(y, k, c, s)=2·N_{cells}·Mₛ·y+N_{cells}·Mₛ·k+Mₛ·c+s. Where y=0 for aperiodic CSI reports to be carried on PUSH, y=1 for semi-persistent CSI reports to be carried on PUSH, y=2 for semi-persistent CSI reports to be carried on PUCCH and y=3 for periodic CSI reports to be carried on PUCCH; k=0 for CSI reports carrying L1-RSRP or L1-SINR, and k=1 for CSI reports not carrying L1-RSRP or L1-SINR, e.g., CSI reports carrying TCI state indication; c is the serving cell index, and N_{cells} is the value of the higher layer parameter associated with the maximum number of serving cells; s is the report configuration identifier (ID) and Mₛ is the value of the higher layer parameter associated with the maximum number of CSI report configurations.

The UE 104 may indicate the number of supported simultaneous CSI calculations. For example, the UE capability may indicate the maximum number of supported simultaneous CSI calculations. A UE supporting N simultaneous CSI calculations is said to have N CSI processing units for processing CSI reports. The CSI processing units may be associated with a serving cell or may be shared across all configured cells. The UE 104 may be configured to occupy L CSI processing unit for the calculation of CSI reports carrying TCI state indications. The value of L may be configured by UE capability, configured by the base station 108, e.g., via RRC signaling, or may be defined by the 3GPP specifications. When the UE capability configures the value of L, the UE 104 may report the value to the base station 108 via RRC signaling. For example, the UE 104 may occupy 0 or 1 CSI processing unit for the calculation of CSI reports carrying TCI state.

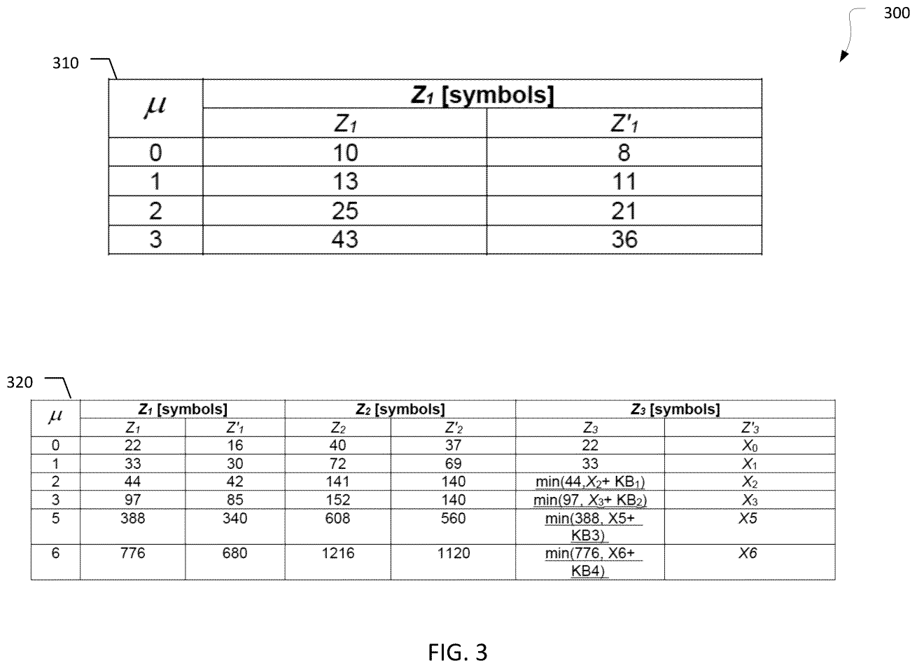

FIG. 3 illustrates aspects of process timelines 300 in accordance with some embodiments. The process timeline may define the time between the following events: the UE receiving a DCI (for aperiodic CSI report), the performing measurement on the allocated measurement resources, and generating or transmitting the CSI report.

In case of periodic or semi-persistent CSI reporting, assume that measurement resources are scheduled at time T1. The report may be generated or scheduled for transmission at time T1+T2.

In one example, when a single CSI-RS or synchronization signal block (SSB) resource is configured for channel measurement, T2 is the smallest value greater than or equal to 4.2″ (milliseconds). Where u is the downlink subcarrier spacing (SCS), e.g., u=0 for SCS=15 kHz, u=1 for SCS=30 kHz, u=2 for SCS=60 kHz, . . . and u=k for SCS=15·2^{k} kHz. For example, T2=4 ms for u=0.

In one example, when multiple CSI-RS or SSB resources are configured for channel measurement, T2 is the smallest value greater than or equal to 5·2^{u} ms. For example, T2=5 ms for u=0.

The periodic or semi-persistent CSI report carrying TCI state may follow the above process timeline, e.g., a 4 or 5 ms process timeline.

In case of aperiodic CSI, the network, e.g., the base station, may request the aperiodic CSI report. For example, the network may send a DCI requesting an aperiodic CSI report. Tables 310 and 320 are examples that may define the process timeline. The UE may be configured to follow a short CSI processing timeline. When the UE follows the short CSI processing timeline, it may follow the information associated with the Z1 [symbols]. When the UE follows a medium CSI processing timeline, the UE may follow the information associated with the Z2 [symbols], and when the UE follows a long CSI processing timeline, it may use Z3 [symbols]. Table 310 may be associated with legacy UEs supporting SCS indices u=0, 1, 2, and 3, and table 320 may be associated with UEs supporting SCS indices u=0, 1, . . . , 6.

For example, a UE using a short CSI processing timeline may use the Z1 [symbols] columns, e.g., Z1 and Z′1 columns. The Z1 column may indicate the minimum time (in terms of symbols) between the time the UE receives the DCI requesting the aperiodic CSI report and the time that the network schedules the UE for generating or transmitting the report. The Z2 column may indicate the minimum time (in terms of symbols) between the time that the measurement resources are scheduled and the time the CSI report is scheduled.

For example, consider a UE supporting SCS indices u=0, 1, . . . 6, having a SCS of 15 KHZ, e.g., u=0, and following a short CSI processing timeline, e.g., using Z1 [symbols] columns of table 320 having Z1=22 and Z′1=16 symbols. The Z1=22 may indicate that there may be at least 22 symbols between the DCI requesting the aperiodic CSI and the time the UE is scheduled for transmission or generation of the CSI report. The UE may not expect to be scheduled for transmission of the CSI report in less than 22 symbols from receiving the DCI requesting the aperiodic CSI report. The Z′1=16 may indicate that there may be at least 16 symbols between the symbol in which the measurement resources are scheduled and the symbol in which the generation or transmission of the aperiodic CSI report is scheduled.

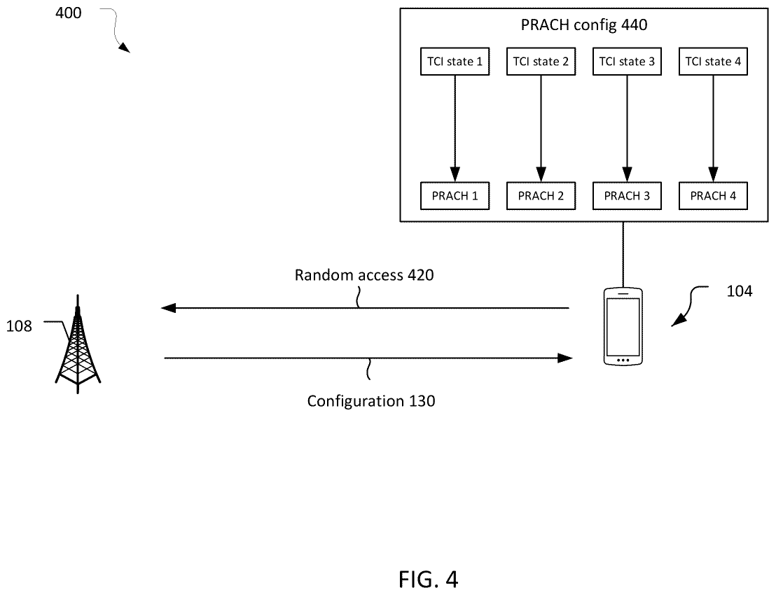

FIG. 4 illustrates a network environment 400 in accordance with some embodiments. The configuration 130 may configure the UE 104 to generate and report its preferred TCI state using a physical random access channel (PRACH) 420.

The configuration 130 may configure the UE 104 to associate a TCI state or a set of TCI states with a PRACH or an attribute of a PRACH. An attribute of a PRACH may include PRACH occasion, e.g., the time domain resources allocated to PRACH, PRACH frequency domain allocated resources, PRACH root sequence index or cyclic shift, or PRACH preamble format, e.g., number of repetitions, or cyclic prefix duration. For example, the configuration 130 may include PRACH configuration 440 to associate TCI state 1 with PRACH 1, TCI state 2 with PRACH 2, TCI state 3 with PRACH 3, or TCI state 4 with PRACH 4. PRACH 1-4 may be an attribute of a PRACH. The association may be for both DL and UL unified TCI states or with only DL unified TCI state or UL unified TCI state.

The UE may use a contention-free random access (CFRA) or a contention-based random access (CBRA) to report its preferred TCI state. For example, the configuration 130 may configure CFRA PRACH or CBRA PRACH for reporting the preferred TCI state. The PRACH procedure may be a single PRACH preamble transmission, a four-step PRACH, or a two-step PRACH procedure.

In one embodiment, as described above, the TCI state may be associated with the PRACH or a PRACH attribute. The transmission of PRACH is associated with the TCI, and the UE may report its preferred TCI state to the network. For example, a root sequence index may be associated with a TCI state. By using the root sequence in PRACH transmission, the UE may indicate the associated TCI state to the network.

In another embodiment, the TCI state, e.g., an indication of the TCI state, such as an index, may be included in PRACH messages. For example, message 3 (MSG3) in a four-step PRACH operation may carry UE's preferred TCI state, e.g., may include an index associated with the TCI state. In another instance, message A (MSGA) in a two-step PRACH operation may carry UE's preferred TCI state, e.g., may include an index associated with the TCI state.

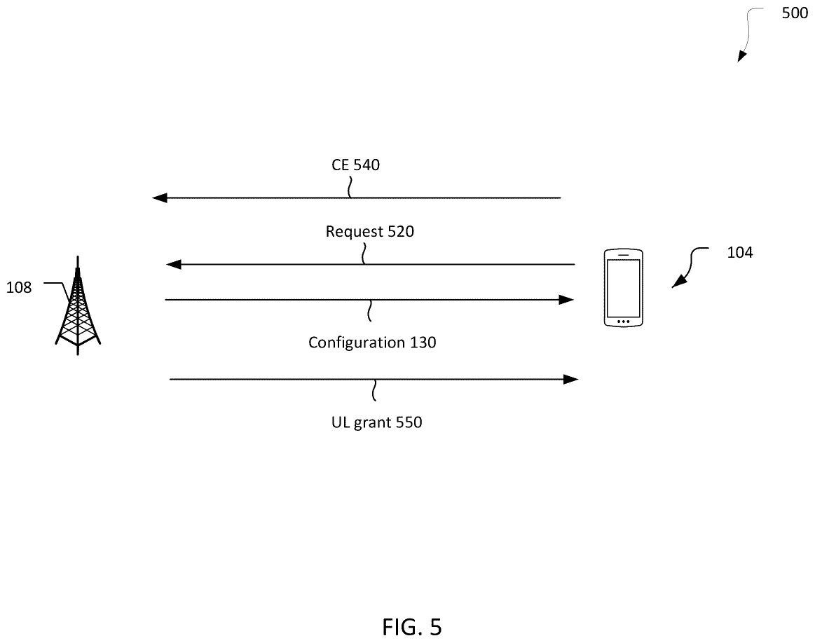

FIG. 5 illustrates a network environment 500 in accordance with some embodiments. The configuration 130 may configure the UE 104 to generate and report its preferred TCI state using a MAC-CE 540.

The base station 108 may send an UL grant 550 to the UE 104. The UL grant 550 may schedule an UL transmission for carrying MAC-CE. The UE may include an indication of its preferred TCI state in the scheduled MAC-CE.

In some instances, the UE may have a preferred TCI state to report to the base station 108 but may not have an UL grant for UL transmission of MAC-CE. The UE may send a scheduling request (SR) 520 to request an UL grant for MAC-CE. In some instances, the UE may include an indication of its preferred TCI state in the scheduling request 520. In some instances, the UE may receive an UL grant 550 in response to the scheduling request 520, and the UE may include an indication of its preferred TCI state in the MAC-CE scheduled by the UL grant 550.

The schedule for transmission of SR for reporting TCI state may collide with the schedule for transmission of SR for link recovery request (LLR) scheduling request. The SR for reporting TCI state may have the same or different priority than the LLR SR. For example, the SR for reporting TCI state may have a lower priority than the LLR SR. The configuration 130 may configure the priority associated with the SR for reporting the TCI state or the LLR SR. In some instances, the priority of SR for reporting TCI state or LLR SR may be defined by the 3GPP specifications.

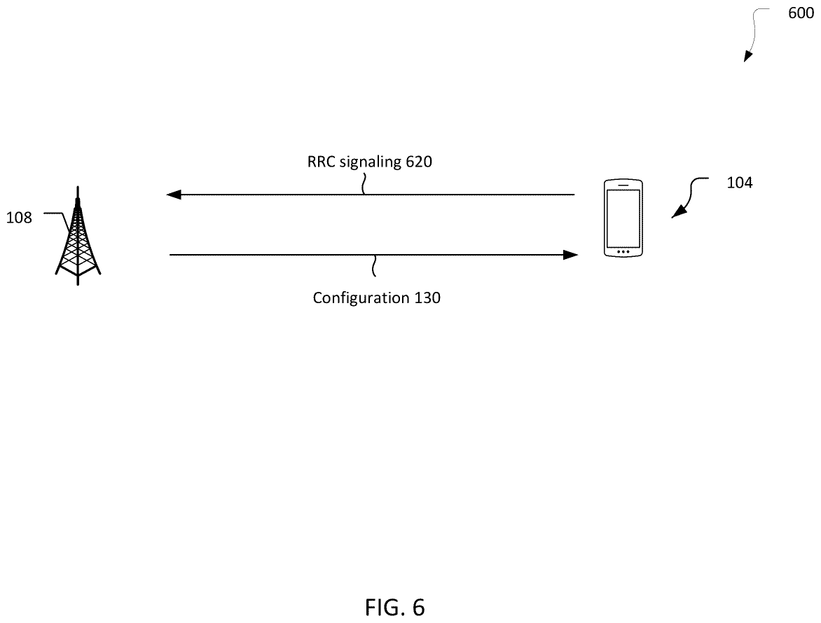

FIG. 6 illustrates a network environment 600 in accordance with some embodiments. The configuration 130 may configure the UE 104 to generate and report its preferred TCI state using an RRC signaling 620. For example, the UE 104 may use UE assistance information (UAI) RRC signaling to report its preferred TCI state to the base station 108.

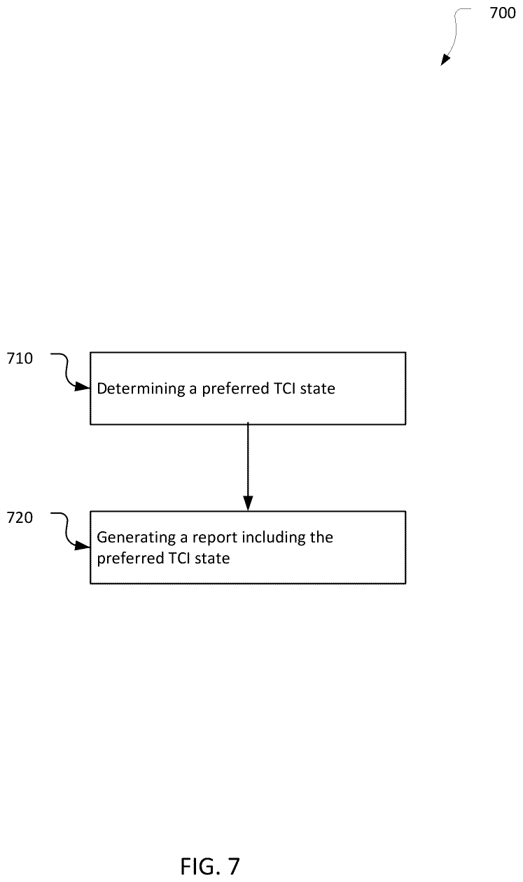

FIG. 7 illustrates an operational flow/algorithmic structure 700 in accordance with some embodiments. Operational flow/algorithmic structure 700 is an example of the UE reporting its preferred TCI state to the base station. The operation flow/algorithmic structure 700 may be implemented by a UE (for example, UE 104 or UE 900) or components therein, for example, processing circuitry 904.

The operation flow/algorithmic structure 700 may include, at 710, determining a preferred TCI state. The UE may perform measurements and determine the preferred TCI state based on the measurements. For example, the UE may determine the preferred TCI state when the difference between the qualities of the currently activated TCI state and the preferred TCI state exceeds a threshold.

The operation flow/algorithmic structure 700 may include, at 720, generating a report including an indication of the preferred TCI state. The indication of the preferred TCI state may be an index associated with the TCI state. The report may be a CSI-RS report, a PRACH message or preamble, an RRC signaling, or a MAC-CE.

The UE may generate the report when a condition is detected. Once the condition is detected, the UE may generate the report. The condition may be detected when a quality measurement of the activated TCI state is less than a first threshold. In another example, the condition may be detected when a difference between a quality measurement of the activated TCI state and a quality measurement of the TCI state is more than a second threshold.

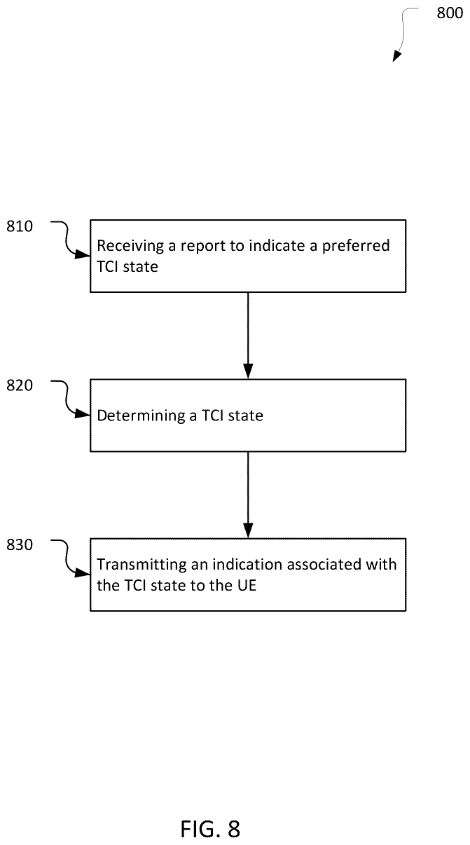

FIG. 8 illustrates an operational flow/algorithmic 800 structure in accordance with some embodiments. Operational flow/algorithmic structure 800 is an example of the operation of the base station 108. The operational flow/algorithmic structure 800 may be implemented by a network node, for example, the network node 1000, or components therein, e.g., processors 1004.

The operation flow/algorithmic structure 800 may include, at 810, receiving a report including an indication of the UE's preferred TCI state. The report may be included in an L1 message, e.g., CSI-RS report or PRACH messages or preamble, an L2 message, e.g., MAC-CE, or an L3 message, e.g., UAI RRC signaling.

The base station may send configuration messages to the UE. The configuration message may configure a set of TCI states to be monitored, measured, or reported by the UE. The configuration message may include an association between a TCI state and a PRACH or PRACH attribute.

The operation flow/algorithmic structure 800 may include, at 820, determining a TCI state.

The operation flow/algorithmic structure 800 may include, at 830, transmitting an indication associated with the determined TCI state to the UE.

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

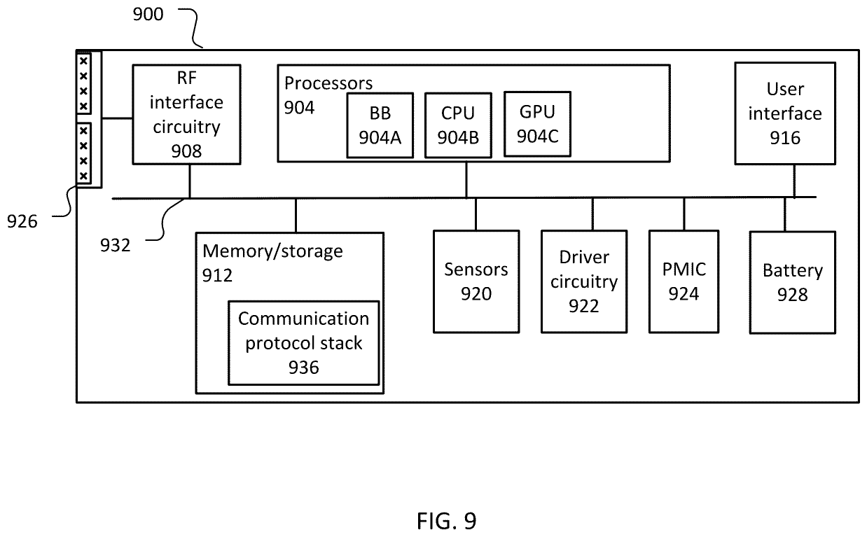

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

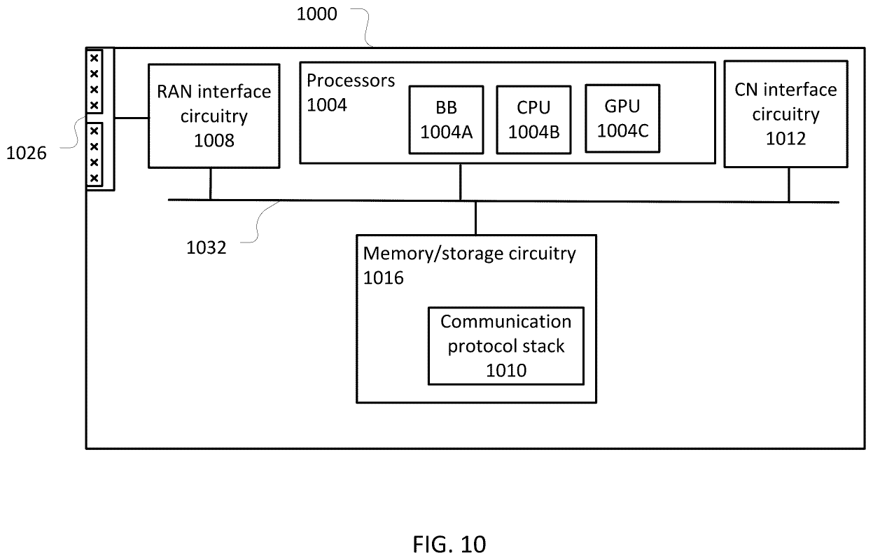

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1032.

The processors 1004, RF interface circuitry 1008, memory/storage circuitry 1016 (including communication protocol stack 1010), antenna structure 1026, and interconnects 1032 may be similar to the like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices generally recognized as meeting or exceeding industry or governmental requirements for maintaining users' privacy. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method to be implemented by a component of a user equipment (UE), the method including: determining a transmission configuration indicator (TCI) state as a preferred TCI state; and generating a report to indicate the TCI state is the preferred TCI state, the report to be transmitted to a base station.

Example 2 includes the method of example 1 or other examples herein, wherein said determining the TCI state as the preferred TCI state includes: performing a measurement associated with the TCI state; and determining the TCI state to be the preferred TCI state based on the measurement.

Example 3 includes the method of examples 1 or 2 or other examples herein, wherein the report is a layer 1 (L1) message, a layer 2 (L2) message, or a layer 3 (L3) message.

Example 4 includes the method of any of examples 1-3 or other examples herein, wherein the report is a channel state information (CSI) report.

Example 5 includes the method of any of examples 1˜4 or other examples herein, wherein the CSI report is associated with a periodic CSI report, an aperiodic CSI report, or a semi-persistent CSI report.

Example 6 includes the method of any of examples 1-5 or other examples herein, wherein the measurement is based on a received reference signal associated with a channel measurement resource (CMR).

Example 7 includes the method of any of examples 1-6 or other examples herein, further including: processing a configuration message to obtain an indication associated with the TCI state.

Example 8 includes the method of any of examples 1-7 or other examples herein, wherein: the configuration message is a CSI report configuration, a radio resource control (RRC) information element, or a medium access control (MAC) control element (CE); and the indication includes a list of TCI states to be measured or reported.

Example 9 includes the method of any of examples 1-8 or other examples herein, wherein the report is a first report and a second report is associated with a CSI report associated with a reference signal received power (RSRP) or signal to interference and noise ratio (SINR), and the method further includes: determining a first priority associated with the first report; determining a second priority associated with the second report; and ordering transmissions of the first report and the second report based on the first priority and the second priority.

Example 10 includes the method of any of examples 1-9 or other examples herein, further including: determining a CSI process unit occupation associated with the report; and processing one or more CSI reports based on the CSI process unit occupation.

Example 11 includes the method of any of examples 1-10 or other examples herein, further including: generating a UE capability report including the CSI process unit occupation to be transmitted to the base station.

Example 12 includes the method of any of examples 1-11 or other examples herein, wherein the report is to be transmitted using a physical random access channel (PRACH).

Example 13 includes the method of any of examples 1-12 or other examples herein, wherein the TCI state is associated with an attribute of the PRACH.

Example 14 includes the method of any of examples 1-13 or other examples herein, wherein the attribute of the PRACH includes a time domain resource allocated to the PRACH, a frequency domain resource allocated to the PRACH, a root sequence index, a cyclic shift, or a PRACH preamble format.

Example 15 includes the method of any of examples 1-14 or other examples herein, wherein the PRACH is based on a contention-free random access or a contention-based random access.

Example 16 includes the method of any of examples 1-15 or other examples herein, wherein the report comprises a medium access control (MAC) control element (CE).

Example 17 includes the method of any of examples 1-16 or other examples herein, wherein the report comprises a radio resource control (RRC) information element (IE).

Example 18 includes the method of any of examples 1-17 or other examples herein, wherein the RRC IE is a UE assistance information.

Example 19 includes the method of any of examples 1-18 or other examples herein, further including: detecting a condition; and generating the report based on said detecting the condition.

Example 20 includes the method of any of examples 1-19 or other examples herein, wherein the UE is configured with an activated TCI state and detecting the condition includes: determining a quality measurement of the activated TCI state is less than a first threshold; or determining a difference between a quality measurement of the activated TCI state and a quality measurement of the TCI state is more than a second threshold.

Example 21 includes the method of any of examples 1-20 or other examples herein, wherein a quality measurement of the activated TCI state or a quality measurement of the TCI state is based on a reference signal received power (RSRP) measurement, a signal to interference and noise ratio (SINR) measurement, a block error rate (BLER) measurement, or a data rate measurement.

Example 22 includes the method of any of examples 1-21 or other examples herein, wherein the first threshold or the second threshold is configured using radio resource control (RRC) signaling.

Example 23 includes the method of any of examples 1-22 or other examples herein, wherein detecting the condition includes: determining a timer associated with the report is expired.

Example 24 includes the method of any of examples 1-23 or other examples herein, wherein the TCI state is a joint TCI state, a pair of TCI states including a downlink TCI state and an uplink TCI state, a downlink TCI state, or an uplink TCI state.

Example 25 includes the method of any of examples 1-24 or other examples herein, wherein the report includes: the TCI state; or the TCI state and the measurement associated with the TCI.

Example 26 includes the method of any of examples 1-25 or other examples herein, wherein the TCI state is associated with a transmission reception point (TRP).

Example 27 includes the method of any of examples 1-26 or other examples herein, wherein the TRP is a first TRP, the TCI state is a first TCI state associated with the first TRP and the report includes the first TCI state and a second TCI state, the second TCI state associated with a second TRP different from the first TRP.

Example 28 includes the method of any of examples 1-27 or other examples herein, the method further including: generating a message including a list of component carriers using the TCI state, the message to be transmitted to the base station.

Example 29 includes the method of any of examples 1-28 or other examples herein, wherein the message is: a UE capability report to be sent via a radio resource control (RRC) signaling; a UE assistance information message to be sent via a radio resource control (RRC) signaling; or a medium access control (MAC) control element (CE).

Example 30 includes a method to be implemented by a component of a base station (BS), the method including: receiving, from a user equipment (UE), a report to indicate a preferred transmission configuration indicator (TCI) state; determining a TCI state; and transmitting, to the UE, an indication associated with the TCI state.

Example 31 includes the method of example 30 or other examples herein, further including: sending, to the UE, a configuration including a list of TCI states to be monitored and reported by the UE.

Example 32 includes the method of examples 30 or 31 or other examples herein, further including: sending, to the UE, a configuration of a random access channel to associate an attribute of the random access channel with the preferred TCI state.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example includes a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include an apparatus comprising: processing circuitry to perform one or more elements of the method described in or related to any of examples 1-32, or any other method or process describe herein; and interface circuitry, coupled with the processing circuitry, the interface circuitry to communicatively couple the processing circuitry to one or more components of a computing platform.

Another example may include a computer program comprising instructions, wherein execution of the program by a processing element is to cause the processing element to carry out the method, techniques, or process as described in or related to any of examples 1-32, or portions thereof.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining a transmission configuration indicator (TCI) state as a preferred TCI state; and
generating a report to indicate the TCI state is the preferred TCI state, the report to be transmitted to a base station.

2. The method of claim 1, wherein said determining the TCI state as the preferred TCI state comprises:
performing a measurement associated with the TCI state; and
determining the TCI state to be the preferred TCI state based on the measurement.

3. The method of claim 2, wherein the measurement is based on a received reference signal associated with a channel measurement resource (CMR).

4. The method of claim 2, wherein the report includes:
the TCI state; or
the TCI state and the measurement associated with the TCI.

5. The method of claim 1, wherein the report is a layer 1 (L1) message.

6. The method of claim 1, wherein the report is a channel state information (CSI) report.

7. The method of claim 6, wherein the CSI report is associated with a periodic CSI report, an aperiodic CSI report, or a semi-persistent CSI report.

8. The method of claim 1, further comprising:
processing a configuration message to obtain an indication associated with the TCI state.

9. The method of claim 8, wherein:
the configuration message is a CSI report configuration received in a radio resource control (RRC) information element, or a medium access control (MAC) control element (CE); and
the indication includes a list of TCI states to be measured or reported.

10. The method of claim 1, further comprising:
detecting a condition; and
generating the report based on said detecting the condition.

11. The method of claim 10, wherein detecting the condition comprises:
determining a timer associated with the report is expired.

12. The method of claim 10, further comprising:
identifying an activated TCI state; and wherein detecting the condition comprises:
determining a quality measurement of the activated TCI state is less than a first threshold; or
determining a difference between a quality measurement of the activated TCI state and a quality measurement of the TCI state is more than a second threshold.

13. The method of claim 12, wherein a quality measurement of the activated TCI state or a quality measurement of the TCI state is based on a reference signal received power (RSRP) measurement, a signal to interference and noise ratio (SINR) measurement, a block error rate (BLER) measurement, or a data rate measurement.

14. The method of claim 12, wherein the first threshold or the second threshold are configured using radio resource control (RRC) signaling.

15. An apparatus comprising:
processing circuitry to:
determine a transmission configuration indicator (TCI) state as a preferred TCI state; and
generate a report, to be transmitted to a base station, to indicate the TCI state is the preferred TCI state; and
interface circuitry coupled with the processing circuitry to enable communication.

16. The apparatus of claim 15, wherein the processing circuitry is further to:
perform a measurement associated with the TCI state; and
determine the TCI state to be the preferred TCI state based on the measurement.

17. The apparatus of claim 15, wherein the report is a layer 1 (L1) message.

18. The apparatus of claim 15, wherein the report is a channel state information (CSI) report.

19. One or more non-transitory computer-readable media having instructions that, when executed, cause processing circuitry to:
process a report, received from a user equipment (UE), to indicate a preferred transmission configuration indicator (TCI) state;
determine a TCI state; and
generate an indication, to be transmitted to the UE, associated with the TCI state.

20. The one or more non-transitory computer-readable media of claim 19, wherein the instructions, when executed, further cause the processing circuitry to:
generate a configuration, to be transmitted to the UE, including a list of TCI states to be monitored and reported by the UE.
